(19) United States
(12) Patent Application Publication
(10) Pub. No.: US 2011/0123754 A1
(43) Pub. Date: May 26, 2011

(54) STRUCTURAL COLOR DISPLAY MATERIAL AND PRODUCTION METHOD OF THE SAME

(75) Inventors: Aya SHIRAI, Tokyo (JP); Mikio KOUYAMA, Tokyo (JP); Kenshi MIYAJIMA, Tokyo (JP)

(73) Assignee: KONICA MINOLTA BUSINESS TECHNOLOGIES, INC., Tokyo (JP)

(21) Appl. No.: 12/943,989

(22) Filed: Nov. 11, 2010

(30) Foreign Application Priority Data
Nov. 20, 2009 (JP) 2009-264494

(51) Int. Cl. B32B 27/28; B32B 7/12

(52) U.S. Cl. 428/41.8; 428/354

(57) ABSTRACT

Provided is a structural color display material containing a sheet of substrate having: an adhesive layer on a rear surface of the substrate; and a structural color display layer which contains structural color particles and a matrix and exhibits a structural color on a front surface of the substrate, wherein the front surface of the substrate on which is formed the structural color display layer exhibits a water contact angle of 60 to 100°.

### CROSS-REFERENCE TO RELATED APPLICATION

This application is based on Japanese Patent Application No. 2009-264494 filed on Nov. 20, 2009 with Japan Patent Office, the entire content of which is hereby incorporated by reference.

### TECHNICAL FIELD

The present invention relates to a structural color display material which can be stuck to a surface of an object, and also relates to a production method of the structural color display material.

### BACKGROUND

In recent years, a method of using a structural color has been attracting attention as a method of displaying a color without relying on absorption of light by a dye. The structural color has characteristics of producing a high chroma with a high reflectivity and having a high color fading resistance, because it uses reflection of light. As a structural color display material which makes use of the characteristics of the structural color, there was proposed a structural color adhesive sheet. This sheet is composed of a structural color display layer which exhibits a structural color and a substrate sheet which is provided with an adhesive layer on a side of the substrate sheet opposite the structural color display layer, so that it may be stuck on a surface of an object (for example, refer to Patent document 1 and Patent document 2.)

However, in such a structural color adhesive sheet, it may occur that the integration of the structural color display layer and the substrate sheet is not complete. As a result, when a force from the outside is applied in the state of being adhered to a surface of an object, there is a possibility that the structural color display layer may be exfoliated from the substrate sheet, and quality of the stuck structural color display layer may not be held.

Patent document 1: Japanese Patent Application Publication (JP-A) No. 2004-276492

Patent document 2: JP-A No. 2006-28202

### SUMMARY

The present invention is made in view of the above-described situation. An object of the present invention is to provide a structural color display material which has a highly integrated structure composed of a structural color display layer and a substrate sheet, thereby, even if a force from the outside is applied to the state of being adhered to a surface of an object, the structural color display layer is hardly peeled off. An object of the present invention is also to provide a production method of the aforesaid structural color display material.

A structural color display material of the present invention contains a substrate having:

an adhesive layer on one surface of the substrate (it is also called as “a rear surface of the substrate”); and

a structural color layer on the other surface of the substrate (it is also called as “a front surface of the substrate”),

the structural color display layer being composed of structural color particles and a matrix, and capable of exhibiting a structural color,

wherein the front surface of the substrate on which is formed the structural color display layer exhibits a water contact angle of 60 to 100°.

Hereinafter, “the substrate for the structural color display layer” is also called as “the structural color display layer substrate”.

In the structural color display material of the present invention, it is preferable that the aforesaid matrix is composed of at least one of an acrylic resin, a polyethylene resin, a polyester resin and a silicone resin.

Further, in the structural color display material of the present invention, it is preferable that the aforesaid substrate for the structural color display layer is a plastic film, or a coated paper which is formed by forming a resin layer on both surfaces (i.e., a front surface and a rear surface) of a paper support.

In the structural color display material of the present invention, it is preferable that the aforesaid substrate for the structural color display layer shows flexibility.

In the structural color display material of the present invention, it is possible to make a composition in which a releasing material is provided on one surface of the aforesaid adhesive layer opposite the other surface of the aforesaid adhesive layer which is in contact with the aforesaid substrate for the structural color display layer.

In the structural color display material of the present invention, it is possible to make a composition in which a transparent protective layer is provided on one surface of the structural color display layer opposite the other surface of the structural color display layer on which the substrate for the structural color display layer is contacted. By this structure, it is possible to wind the structural color display material in a roll form so that the opposite surface of the aforesaid adhesive layer which is in contact with the substrate for the structural color may be in contact with the surface of the aforesaid protective layer.

The method for producing the structural color display material of the present invention is a method for producing the above-described structural color display material. The method is characterized in that on the rear surface of the substrate is provided with an adhesive layer, with the condition that the front surface of the substrate which is provided with the structural color layer has a water contact angle of 60 to 100°, and on the front surface of the aforesaid substrate is coated with a structural color particle dispersion which is made by dispersing the structural color particles in an aqueous medium to form a periodic structure body which exhibits a structural color.

According to the structural color display material of the present invention, since the structural color display layer which exhibits a structural color is formed on a surface of the substrate for the structural color display layer, the substrate is provided with a surface having a specific high water contact angle, a sufficient fixing state is achieved between the structural color display layer and the substrate for the structural color display layer. Consequently, a highly integrated structure can be achieved for the structural color display layer and the adhesive layer through the substrate for the structural color display layer. As a result, in the state where the adhesive layer is stuck to a surface of an object, even if a force is applied from the outside, the exfoliation of the structural color display layer will not occur and the intrinsic quality of the stuck structural color display layer can be kept.

In addition, according to the structural color display material of the present invention, since the periodic structure body is formed on the substrate for the structural color display layer which has been provided with an adhesive layer beforehand by coating a with a structural color particle dispersion which is made by dispersing the structural color particles in an aqueous medium, the complexity of the process is highly reduced compared with a method in which the adhesive layer is provided after forming the structural color display layer. Further, the method of the present invention can easily produce a large sized material.

### BRIEF DESCRIPTION OF THE DRAWINGS

FIG. 1 is an explanatory cross-sectional view schematically illustrating an example of a constitution of a structural color display material of the present invention.

FIG. 2 is an explanatory cross-sectional view illustrating an expansion of the structural color display layer in the structural color display material of FIG. 1.

FIG. 3 is an explanatory cross-sectional view illustrating another example of a constitution of a structural color display layer of the present invention.

FIG. 4 is an explanatory cross-sectional view schematically illustrating another example of a constitution of a structural color display material of the present invention.

FIGS. 5a and 5b are a schematic diagram showing the measuring method of the fixing force between the structural color display layer substrate and the structural color display layer concerning an example of the structural color display material of the present invention and that of a comparative example.

### DESCRIPTION OF THE PREFERRED EMBODIMENT

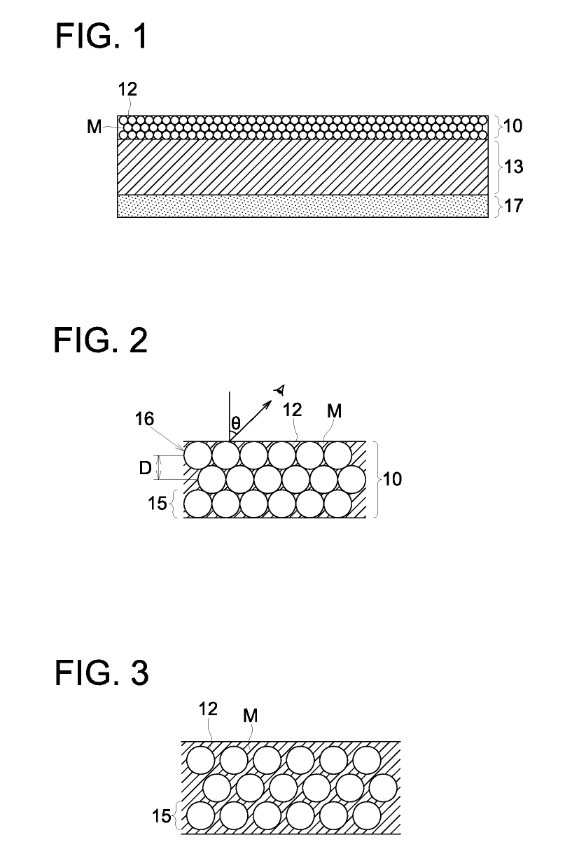

The present invention will be described in detail below. FIG. 1 is an explanatory cross-sectional view schematically illustrating an example of a constitution of a structural color display material of the present invention.

The structural color display material of the present invention is produced as follows. There is formed a structural color display layer 10 which is composed of structural color particles 12 and a matrix M and can exhibit a structural color on one surface (a front surface) of a sheet type of substrate 13, while an adhesive layer 17 has been provided on the other surface (a rear surface) of the substrate 13. The front surface of the substrate 13, on which the structural color display layer is provided, is characterized in that it has a water contact angle of 60 to 100°, more preferably it has a water contact angle of 70 to 90°.

When the water contact angle of the front surface of the substrate 13 for a structural color display layer is in the above-described range, it can be obtained a sufficient fixing condition between the structural color display layer 10 and the substrate 13 for a structural color display layer. On the other hand, when the water contact angle of the front surface of the substrate 13 for a structural color display layer is less than 60°, or larger than 100°, it cannot be obtained a sufficient fixing condition between the structural color display layer 10 and the substrate 13 for a structural color display layer. As a consequence, a highly integrated structure cannot be achieved for the structural color display layer 10 and the adhesive layer 17 through the substrate 13 for a structural color display layer. As a result, in the state where the adhesive layer 17 is stuck to a surface of an object, when a force is applied from the outside, the exfoliation of the structural color display layer 10 may occur and the inherent quality of the stuck structural color display layer 10 may not be kept.

A water contact angle of a surface of the substrate 13 for a structural color display layer can be measured as follows.

Namely, a contact angle is measured as a contact angle with respect to pure water using a contact angle meter “CA-DT•A type” (made by a Kyowa Interface Science Co., Ltd.) under the ambient of the temperature of 20° C., and the humidity of 50% RH.

### [Structural Color Display Layer Substrate]

The substrate 13 for a structural color display layer which constitutes the structural color display material of the present invention is preferably, for example, a plastic film, or a coated paper which is formed by forming a resin layer on both surfaces (i.e., a front surface and a rear surface) of a support made of paper (it is also called as a paper support). It is preferable that the resin layer in the coated paper has high water resistivity.

As a material for the paper support of the coated paper, it can be cited: a natural pulp, a synthetic pulp, a mixture of a natural pulp and a synthetic pulp, and various types of raw materials for making paper. As natural pulp, a hardwood pulp, a softwood pulp, and a mixed pulp of a softwood pulp and a hardwood pulp can be cited. The body paper produced by paper making can be classified into an acid-free paper and an acid paper according to a manufacturing process. Although as a paper support, it can be used any type of body paper determined by the manufacturing process, it is preferable to use the body paper of a printing paper grade for photograph, especially an acid-free paper of a printing paper grade for photograph is preferably used.

As for a paper support, it is preferable that the paper support itself has water resistance. By using the paper support having itself water resistance, it can be prevented the penetration of an aqueous medium from a cut surface of the paper support, when a structural color particle dispersion is applied in the manufacturing process which will be mentioned later. As a consequence, quality deterioration of the obtained structural color display material can be prevented. As a paper support which has water resistance, there can be cited materials blended at the time of paper making with an additive such as: a sizing agent, a fixing agent, a tensile force enhancement agent, a loading material, an antistatic agent, a dye and an antifoggant. Moreover, it can be used a material suitably coated with a surface sizing agent, a surface tension agent, or an antistatic additive on the surface of the material.

Examples of a material for a resin layer formed on a front surface and a rear surface of a paper support include: a polyolefin resin such as polyethylene and polypropylene; a polyester resin such as polyethylene terephthalate, polyethylene naphthalate and modified polyester; a polyether resin such as polyoxymethylene and polyoxypropylene; a polyurethane resin such as polyester urethane and polyether urethane; a polycarbonate resin; and a polystyrene resin. These can be used solely or can be used by mixing two or more sorts. Among these, a polyethylene resin and a polyester resin are preferable and they may be uses independently. It may be used them by making them as a main ingredient and mixed with other arbitrary resins above-mentioned.

As a polyethylene resin, both low density polyethylene and an high density polyethylene can be used preferably. These can be used solely or can be used by mixing two or more sorts.

As a specifically preferable material for forming a resin layer, there can be cited: a polyethylene terephthalate resin, a polyethylene naphthalate resin, and a modified polyester resin (hereafter, it is called as “a specific modified polyester resin”) having polyethylene terephthalate as a main structure. The specific modified polyester resin is composed a polyester section made of a polyethylene terephthalate structure which occupies the most parts of the main chain and a modified portion. The modified portion in the main chain has an ester structure made of a dibasic acid and a glycol.

Examples of a dibasic acid are: terephthalic acid, isophthalic acid, 2,6-naphthalene dicarboxylic acid, 1,5-naphthalene dicarboxylic acid, 1,4-naphthalene dicarboxylic acid, 2,7-naphthalene dicarboxylic acid, p-xylydene dicarboxylic acid, 1,4-cyclohexanedicarboxylic acid, adipic acid, sebacic acid, 5-alkali metal sulfo-isophthalic acid and 4-alkali metal sulfo-2,6-naphthalene dicarboxylic acid.

Examples of a glycol are: ethylene glycol, propylene glycol, 1,4-butanediol, 1,4-hexylenediol, 1,4-benzenediol (hydroquinone), 1,4-cyclohexanediol, 1,4-cyclohexanedimethanol, diethylene glycol, triethylene glycol, tetraethylene glycol, polyethylene glycol (number average molecular weight of 300 to 30,000), polypropylene glycol (number average molecular weight of 300 to 30,000). In addition, as an alkali metal in an alkali metal of sulfo group in the above description, cites examples are: sodium, potassium, lithium and cesium. Preferably, it is sodium.

Among them, a more preferable modified portion in the main chain has an ester structure made of a dibasic acid and a glycol as follows.

Examples of a dibasic acid are: terephthalic acid, isophthalic acid, 2,6-naphthalene dicarboxylic acid, 1,4-cyclohexanedicarboxylic acid, 5-alkali metal sulfo-isophthalic acid and 4-alkali metal sulfo-2,6-naphthalene dicarboxylic acid.

Examples of a glycol are: ethylene glycol, propylene glycol, 1,4-cyclohexanedimethanol, polyethylene glycol (number average molecular weight of 300 to 30,000).

Moreover, when it is used a compound containing an alkali metal sulfo group as a dibasic acid, it is also preferable to form a modified portion by using polyethylene glycol as a glycol and/or a saturated aliphatic dicarboxylic acid, for example, adipic acid.

A content of the modified portion in the main chain is preferably 50 mol % or less as a ratio of an ester bond concerned with the modified portion based on the total ester bonds in the molecule. More preferably, it is 40 mol % or less, and still more preferably, it is 30 mol % or less. When the ratio of the ester bond concerned with the modified portion is more than 50 mol % based on the total ester bonds in the molecule, it may possible that the obtained substrate for a structural color display layer will become a low mechanical strength, low glass transition temperature and low water resistivity.

When a composition unit of an alkali metal sulfo group is contained in the modified portion, the ester bond concerned with the alkali metal sulfo group is preferably contained in an amount of 2 to 10 mol % based on the total ester bonds in the molecule. More preferably, it is 2 to 7 mol % or less, and still more preferably, it is 3 to 6 mol % or less. By using the substrate 13 for a structural color display layer, which contains the ester bond of the alkali metal sulfo group in an amount of the above-described range, it is possible to achieve an excellent fixing state between the structural color display layer 10 and the substrate 13. When the compound which provides this alkali metal sulfo group is, for example, 5-sodiumsulfo-isophthalic acid, if the ratio of the ester bond of the sodium sulfo group is less than 2 mol % based on the total ester bonds in the molecule, the specific modified polyester resin is almost identical to polyethylene terephthalate, and as a consequence, improvement of a fixing state between the structural color display layer 10 and the substrate 13 cannot be fully obtained. On the other hand, if the ratio of the ester bond of the sodium sulfo group is more than 10 mol % based on the total ester bonds in the molecule, a water absorbing ratio becomes large, and as a consequence, the close contact state between the paper support and the resin layer tends to be deteriorated in the obtained substrate 13 for a structural color display layer. It may take place peeling off during the manufacturing process. Further, its water resistance becomes low and it may possible that this substrate cannot be used for the substrate for a structural color display layer according to the structural color display material of the present invention.

The aforesaid specific modified polyester resin can be synthesized in accordance with the well-known manufacturing process for polyester. Specifically, it may use a direct esterification method which carries out a direct reaction of a dibasic acid and glycol as an esterification reaction, or it may use a trans-esterification method in which glycol is made to react with dimethyl ester after making a dibasic acid into dimethyl ester as an esterification reaction. In producing this specific polyester resin, a trans-esterification catalyst may be added according to necessity during the esterification reaction. Further, in the polymerization reaction, a polymerization catalyst like antimony oxide may be used if needed for synthesis.

The synthesis of the aforesaid specific modified polyester resin can be done by referring to the description of, for example, Polymer Experiments, 5^{th} volume “Polycondensation and polyaddition” pages 103 to 136 (Kyoritsu Shuppan Co., Ltd., 1980), or “Synthetic polymer V”, pages 187 to 286 (Asakura Publishing Co., Ltd., 1971). More specifically, this specific modified polyester resin can be synthesized according to the description of the U.S. Pat. No. 4,217,441 and JP-A No. 5-210199.

When a polyester resin is used as a material for a resin layer of a coated paper, this polyester resin is required to have a sufficiently high molecular weight. Specifically, it is preferable that the polyester resin has an intrinsic viscosity of 0.40 to 0.75. Since stabilized melt extruding can be performed, it is especially preferable that the polyester resin has an intrinsic viscosity of 0.45 to 0.65. When a polyester resin having an intrinsic viscosity of less than 0.40 is used, there is a possibility that the resin layer by the polyester resin concerned will become whitened, and will become weak, after it is melt extruded. Moreover, it is necessary to use the resin chips which are fully removed water by fully drying the resin chips for obtaining the polyester resin. Desiccation of the resin chips is usually performed at about 150° C. under the vacuum of about 10⁻³ Torr. When melt extruding is performed using resin tips containing water, there is a possibility that intrinsic viscosity may fall extremely, or there is a possibility of causing hydrolysis during melting even if intrinsic viscosity is high enough.

Specifically, the resin layer in the coated paper is formed by the steps of: melt extruding and applying the material for forming a resin layer such as such as a polyolefin resin and a polyester resin on paper support to laminate the material.

This melt extruding-applying method is a coating method in which melting of the material (a resin composite) for forming the resin layer is carried out to a prescribed temperature, application of it is performed from a die slit to the paper support which runs. The resin composition layer formed by application may be a monolayer from a single slit, and it may be two or more layers applied from two or more slits.

Resin layers of a coated paper formed on the front surface and the rear surface of a paper support, respectively are not limited to the layers being formed by the method of laminating using the above-described materials. For example, it can be used an electron beam curable resin composition containing a compound cured by irradiating with an electron beam as a material for forming the resin layers (hereinafter, this compound is also called “an electron beam curable compound”). It is possible to adopt the method of applying this composition on a paper support, followed by irradiating the coated resin layer with an electron beam. The aforesaid method is disclosed in, for example, JP-A No. 57-27257, JP-A No. 57-49946, JP-A No. 61-262738 and JP-A No. 62-61049.

As an electron beam curable compound, an electron beam curable monomer or oligomer disclosed in the following documents are cited, for example: JP-B No. 60-17104, JP-A No. 60-126649 and JP-A No. 2-157747. Specifically, it can be cited an unsaturated compound which contains two or more carbon-carbon double bonds in one molecule, such as an acrylic system or a methacrylic system oligomer; and a polyfunctional acrylic system or a methacrylic system monomer. Radical polymerization of these unsaturated compounds is carried out by irradiation of an electron beam. Crosslinking bonds are formed by a cross-linking reaction i between molecules to be hardened resulting in producing a cured resin.

Specific examples of an unsaturated compound can be cited as: (meth)acrylic acid ester of polyurethane, (meth)acrylic acid ester of polyether alcohol, (meth)acrylic acid ester of bisphenol A or an epoxy condensation of bisphenol A, 1,6-hexane di(meth)acrylate, neopentyl di(meth)acrylate, diethylene glycol di(meth)acrylate, butadiene acrylate or diacrylate, tetraethylene glycol di(meth)acrylate, glycerol tri(meth)acrylate, polyethylene glycol (recurring unit n=4 to 300) di(meth)acrylate, 1,4-butane diol di(meth)acrylate, neo pentyl glycol di(meth)acrylate, isocyanuric acid di(meth)acrylate, isocyanuric acid tri(meth)acrylate, trimethylolpropane tri(meth)acrylate, propylene oxide modified trimethylolpropane polyacrylate, 1,3-bis(N,N-diepoxy propylaminomethyl) cyclohexane, pentaerythritol pentaacrylate, maleic acid ester or fumaric acid ester of polyester, condensation polyester or oligoester of an organic acid of 2 or more values such as adipic acid with an alcohol of 2 or more values such as ethylene glycol, and di-(meth)acrylate or poly(meth)acrylate of polyester

When the viscosity of an electron beam curable resin composition needs to be adjusted, it can be contained a diluting monomer having one unsaturated double bond and can be incorporated into the crosslinking polymer body in the electron beam curable resin composition in addition to an electron beam curable compound. As this diluting monomer, it can be cited an unsaturated compound which contains at least one carbon-carbon double bond in the molecule, such as a monofunctional acrylic monomer, methacrylic monomer, and vinyl monomer. Specific examples of this diluting monomer include: glycidyl (meth)acrylate, methyl (meth)acrylate, ethyl (meth)acrylate, n-propyl (meth)acrylate, iso-propyl (meth)acrylate, butyl (meth)acrylate, 2-hydroxyethyl (meth)acrylate, 2-hydroxypropyl (meth)acrylate, phenoxyethyl (meth)acrylate, cyclohexyl (meth)acrylate, benzyl (meth)acrylate, N,N-dimethyl aminoethyl (meth)acrylate, N,N-diethylamino (meth)acrylate, acrylic acid ester of ethylene oxide modified phenoxy phosphoric acid acrylate, styrene, polyoxyethylene phenyl alcohol and 2-ethylhexyl acrylate.

Moreover, in the electron beam curable resin composition, although an organic solvent may be made to contain as a diluent if needed, it is desirable to irradiate an electron beam after fully evaporating off this organic solvent so that it may not remain in the coated film of the electron beam curable resin composition. As an organic solvent, it can be used, for example: acetone, methyl ethyl ketone, ethyl acetate, butyl acetate, ether, glycol monoethyl ether, dioxane, benzene, toluene and xylene.

As a method for coating an electron beam curable resin composition on a paper support, it can be used any one of the following methods: a roll coat method, a bar coat method, an air doctor coat method, a plate coat method, a squeeze coat method, an air knife method, a reverse roll coat method, and a transfer coat method. Further, it can be used a method of a fountain coater mode or a slit orifice coater mode.

As characteristics of the electron beam for curing the electron beam curable resin composition coated on the paper support, it is preferable the electron beam having the following characteristics: applied voltage of 100 to 1,000 kV, more preferably, of 100 to 300 kV, absorbed dose of 0.5 to 20 mega rad (mrad), more preferably, of 0.5 to 10 mrad. As an electron beam accelerator which emits such an electron beam, it can be cited a Van de Graaff type scanning mode, a double scanning mode and a curtain beam mode.

When the substrate 13 for a structural color display layer is made of a coated paper, the coating amount of the material for forming a resin layer is suitably chosen so that the thickness of the resin layer become in the range which will be mentioned later.

As a plastic film, it can be cited: a polyester film, a laminated polyester film made of a non modified polyester film and a modified polyester film, a polycarbonate film, a polyvinyl chloride film, a polypropylene film and a polystyrene film. A polyester film is preferably used from the ease of carrying out of production, the properties of a film, and the ease of carrying out of adhesion.

As a material for a polyester film, it can be used the above-described specific polyester resin, for example. By making a film of this specific polyester resin with the conventionally known method for polyethylene terephthalate, a polyester film can be obtained.

It is preferable that the intrinsic viscosity of specific polyester resin is 0.50 to 0.58, more preferably, it is 0.55 to 0.70. However, when a laminated film is formed, the intrinsic viscosity of the modified polyester is preferably in the range of 0.40 to 0.60 from the advantage on handling.

The substrate 13 for a structural color display layer according to the present invention is preferably a plastic film. In particular, a polyester film is most preferably used.

The above-described substrate 13 for a structural color display layer is preferable to be colored (such as black or gray) by absorbing a predetermined light, and particularly it is colored as black. The substrate 13 in itself may be colored, or in the case of the coated paper, the resin layer which contacts with the structural color display layer 10 may be colored. When the substrate 13 for a structural color display layer is made of a coated paper, the coated paper itself or the resin layer of the front surface of the coated paper may exhibit any colors.

The aforesaid black can be obtained by incorporating a black pigment in the substrate itself when the substrate 13 for a structural color display layer is made of a plastic film. And the aforesaid black can be obtained by incorporating a black pigment in the resin layer of the front surface which contacts with the structural color display layer 10. Examples of the black pigment include: carbon black, aniline black, iron oxide and titanium black. These may be used solely, or may be used 4 in combination of two or more sorts. The content of the black pigment is preferably 4 to 70% as a concentration in the resin layer. Moreover, it may be added a tincture adding dye or a pigment such as cobalt blue, ultramarine blue, an organic dye such as phthalocyanine dye, with these black pigments. The content of a tincture adding dye or a pigment is preferably 0.0001 to 0.05 weight % based on the total colorant including the black pigment.

There are the following methods for incorporating a black pigment. One of the methods is for incorporating a black pigment in a front surface resin layer which contacts with the structural color display layer 10 when the substrate 13 for a structural color display layer is made of a coated paper. When the resin layer concerned is formed of laminating, the resin chips for forming the resin layer are dried applying temperature under a high vacuum condition, then, a black pigment is directly supplied in an extruder so that it may become the prescribed concentration, and carrying out melt-mixing the resin at the prescribed temperature in the range of 200 to 350° C. Moreover, there is another method in which resin chips and a black pigment are melt-mixed beforehand with a kneading machine, such as a kneader, to obtain colored chips having a prescribed concentration, then the colored chips are dried under vacuum. Then the dried colored chips are directly, or after mixed with colorless chips so as to realize a prescribed concentration, mixed with an extruder. Further, there is another method in which a black pigment is incorporated beforehand in an electron beam curable resin composition, when the above-mentioned resin layer is formed by irradiating to cure with an electron beam.

Moreover, about the plastic film used for the substrate 13 for a structural color display layer, there is know a method of incorporating a black pigment. This method contains the steps of: carrying out melt-mixing of resin chips and a black pigment with a kneading machine, such as a kneader, beforehand, to obtain colored chips of a prescribed concentration; drying the colored chips under vacuum; and making a plastic film directly with the dried colored chips, or after mixed with colorless chips so as to realize a prescribed concentration.

The thickness of the substrate 13 for a structural color display layer is made to be, for example, 10 to 300 μm. Particularly, when the substrate 13 for a structural color display layer which composes the structural color display material is made of a coated paper, it is preferable that the thickness of the paper support is, for example, 40 to 100 μm, and the thickness of the resin layer is, for example, 10 to 40 μm, which enable to achieve water resistance when the resin layer is made of a laminated film. In addition, when the resin layer is made of a cured film obtained by an electron beam curable resin composition, it is preferable that the thickness of the resin layer is, for example, 5 to 30 μm. When the substrate 13 for a structural color display layer which composes the structural color display material is made of a plastic film, it is preferable that the thickness of the plastic film is 40 to 130 μm, it is particularly preferable to be 50 to 100 μm from the ease of handling.

The substrate 13 for a structural color display layer which composes the structural color display material of the present invention is preferable to exhibit flexibility. In addition to such substrate 13 for a structural color display layer, by making the structural color display layer 10 and the adhesive layer 17 to be flexible compositions, it is possible to make the whole structural color display material to be flexible. As a result, the structural color display material can be kept in a rolled state and it can be adhered to an object other than a plane.

### [Structural Color Display Layer]

The structural color display layer 10 which constitutes the structural color display material of the present invention is composed of a periodic structure body 16 formed in a matrix M. Formation of such a periodic structure body in the structural color display layer 10 makes it possible to recognize a chromatic color by irradiation with a light in a visible range.

The structural color display layer 10 has a regularly arranged structure as is shown in FIG. 2 in which structural color particles 12 made of solid particles are regularly arranged in contact with each other in a matrix M in plane direction so as to form a structural color particle layer 15. In the structural color particle layer 15, the structural color particles 12 are regularly arranged to be in a state of contact with each other in a depth direction.

Moreover, when the matrix M is a solid, the display layer may have a regularly arranged structure as is shown in FIG. 3. In which, the structural color particles 12 made of solid particles are regularly arranged in non-contact with each other in a matrix M in plane direction to form a the structural color particle layer 15. And in the particle layer 15, the particles 12 are regularly arranged to be in a state of non-contact with each other in a depth direction.

The structural color particle layer 15 has a composition in which the particles 12 are regularly arranged to be located in one direction with respect to a direction of an incident light. In particular, it is preferable that the structural color particle layer 15 will form a periodic structure body of a closest packed structure of a face cubic structure such as a cubic close-packed structure, or of a hexagonal close-packed structure arranged with the particles 12.

In the structural color display layer 10, an absolute value of a difference between a refractive index of the structural color particles 12 and the matrix M (hereafter it is called as “a refractive index difference”) is preferably from 0.02 to 2.0, and it is more preferably from 0.1 to 1.6.

When this refractive index difference is less than 0.02, the structural color is hard to be realized. And, when this refractive index difference is more than 0.02, the light scattering will be large and the obtained structural color becomes clouded to yield white turbidity. And it is hard to recognize the displayed color.

A preferable example of the thickness of the structural color particle layer 15 in the structural color display layer 10 is from 0.1 to 100 μm.

When the thickness of the structural color particle layer is less than 0.1 μm, the density of the obtained structural color maybe pale. On the other hand, when the thickness of the structural color particle layer is more than 100 μm, the light scattering my become so considerable that the structural color will become clouded. As a result, it becomes hard to recognize the displayed color.

In the structural color display layer 10, the repeating number of the structural color particle layer 15 is preferably 1 or more, and more preferably from 5 to 500.

In the case where the repeating number is less than 1, the structural color display layer is not allowed to exhibit the structural color.

In the structural color display material of the present invention, the displayed color produced by a structural color is a color having a peak wavelength in a visible range.

### [Structural Color]

The structural color obtained with the structural color display layer 10 is not a color generated by a light absorption by dyes and the like, but a reflection color of selected light generated by a periodic structure body and the like. The structural color can be generated by, for example, thin film interference, light scattering (such as Rayleigh scattering and the Mie scattering), multilayer interference, a diffraction grating, and a photonic crystal.

The structural color display layer 10 has a composition which is capable of reflecting a light by this structural color display layer 10. The light of the wavelength determined by the observing angle is selectively reflected to result in exhibiting a structural color.

The selectively reflected light by the structural color display layer 10 is a light having a wavelength represented by Scheme (1) based on Bragg's Law and Snell's Law.

In addition, the following Scheme (1) and Scheme (2) are an approximation. And, the obtained values may not be fully corresponded to the calculated values.

λ=2nD(cos θ) Scheme (1)

In Scheme (1), λ represents a peak wavelength of the structural color, n represents a refractive index of the structural color display layer 10 represented by Scheme (2) below, D represents a layer interval between the structural color particle layers 15 (the distance in the direction of perpendicular to the structural color display layer 10 made of structural color particles 12), and θ represents a viewing angle to a perpendicular line of the structural color display layer 10.

n={na·c}+{nb·(1−c)} Scheme (2)

In Scheme (2), na represents a refractive index of the structural color particles 12, nb represents a refractive index of the matrix M, and c represents a volume fraction of the structural color particles 12 in the structural color display layer 10.

Here, the peak wavelength of the structural color λ, can be measured using MCPD-3700 (made of OTSUKA ELECTRONICS Co., Ltd.) which allow to confirm the relationship between the light source and the viewing angle by making use of a glass fiber.

The layer interval D in the structural color display layer 10 is preferably from 50 to 500 nm. By setting the layer interval D in the aforesaid range, the obtained structural color by the structural color display layer 10 becomes to have a peak wavelength in the visible range. While, when the layer interval D is larger than 500 nm, the obtained structural color display layer 10 may not exhibit a structural color.

### [Structural Color Particle]

In the present invention, a structural color particle is a material that forms a spherical shape in three dimensions. It is not limited to a complete spherical shape but it may be an approximate spherical shape. The material for the particle is preferably a solid, however, when the matrix M is a solid, the material for the particle may be a liquid or a gas.

The material for producing structural color particles in the structural color display layer 10 may be suitably selected by considering the materials for producing the matrix M.

To be more precise, the refractive index of the structural color particles is required to be different from the refractive index the material for producing the matrix M; and the material for producing structural color particles is required to be immiscible with the material for producing the matrix M. Further, the material for producing the structural color particles 12 is preferable to have a high affinity with the material for producing the matrix M.

Various substances can be cited for the structural color particles 12 which form the structural color display layer 10.

Specific examples of the substances are organic particles prepared by polymerization of a single polymerizable monomer, or polymerization of two or more kinds of polymerizable monomers, which monomer includes a styrene monomer such as styrene, methyl styrene, methoxy styrene, butyl styrene, phenyl styrene, and chlorostyrene; an acrylic acid ester monomer or a methacrylic acid ester monomer such as methyl acrylate, ethyl acrylate, (iso)propyl acrylate, butyl acrylate, hexyl acrylate, octyl acrylate, ethylhexyl acrylate, methyl methacrylate, ethyl methacrylate, butyl methacrylate, and ethylhexyl methacrylate; a carboxylic acid monomer such as acrylic acid, methacrylic acid, itaconic acid, and fumaric acid.

Further, the resins for forming the structural color particles 12 may be a polymer produced from a polymerizable monomer added with a cross-linkable monomer. The cross-linkable monomers include divinylbenzene, ethylene glycol dimethacrylate, tetraethylene glycol dimethacrylate, and trimethylol propane trimethacrylate.

Other listed examples of the substances are inorganic particles made of inorganic oxide such as silica, titanium oxide, alumina, and copper oxide, and composite oxide; and particles formed from glass, or ceramic.

Further listed examples are core-shell type particles having core particles made of the aforesaid organic particles or inorganic particles each covered with a shell made of a material different from the materials for forming the core particles. The shell layer may be made of metal fine particles, metal oxide fine particles such as titania, metal oxide nano-sheet made of titania.

More listed examples of the substance are hollow type particles which are produced by eliminating the core portion of the aforesaid core-shell particles by applying calcination or extraction for the aforesaid core-shell particles.

Among the aforesaid particles, the organic particles are suitably used for the substances for spherical bodies.

An average particle diameter of the structural color particles 12 must be set by considering the relationship of a refractive index of the structural color particles 12 and a refractive index of the matrix M. In addition to that, the spherical bodies 12 are required to form a stable colloid solution when they are dispersed. For that reason, the average particle diameter of the structural color particles 12 is preferably from 50 to 500 nm.

By controlling the average particle diameter of the structural color particles 12 to be in the range of the aforesaid range, the dispersion thereof can be a stable colloid solution, and at the same time, the structural color exhibited by the obtained display member will have a peak wavelength in the range of the visible range.

On the other hand, when the average particle diameter of the structural color particles is less than 50 nm, there is a possibility that the observed structural color may become to have a small color density. When the average particle diameter of the structural color particles is larger than 500 nm, it may produce a large amount of scattering of light, which will result in cloudiness of the observed structural color. As a result, the displayed color may be hardy recognized.

The CV value indicating a particle distribution of the structural color particles 12 is preferably 10 or less, more preferably 8 or less, and particularly preferably 5 or less.

When the CV value is more than 10, the structural color particle layer which should be regularly arranged in the matrix may be disorderly arranged, and as a result, the obtained structural color particle layer will exhibit cloudiness and a structural color may be hardly recognized. An average particle diameter can be obtained employing a scanning electron microscope “JSM-7410” (manufactured by JEOL Ltd.) as follows: (i) to take a photograph of the structural color particles 12 at a magnification of 50,000 times; (ii) to determine a maximum length by measuring arbitral 200 structural color particles 12 in the photographs; and (iii) to calculate a number-based average value thereof. The term “the maximum length” refers to the maximum length of lengths between any two points on circumference of each of the structural color particles 12.

Incidentally, when a picture of the structural color particles 12 is taken as an aggregation, the maximum length of the primary particles which forms the aggregation is measured.

The CV value is calculated by Formula (CV) below employing the standard deviation of the number-based particle distribution and the above average particle diameter.

CV value(%)=((standard deviation)/(average particle diameter))×100 Formula (CV)

The refractive index of the structural color particles 12 can be measured using various known methods. The refractive index of the structural color particles 12 according to the present invention is a value obtained by the immersion method.

Examples of a refractive index of the structural color particles 12 are as follows: polystyrene 1.59, polymethyl methacrylate 1.49, polyester 1.60, fluorine modified polymethyl methacrylate 1.40, polystyrene butadiene copolymer 1.56, polymethyl acrylate 1.48, polybutyl acrylate 1.47, silica 1.45, titanium oxide (anatase type) 2.52, titanium oxide (rutile type) 2.76, copper oxide 2.71, aluminium oxide 1.76, barium sulfate 1.64 and ferric oxide 3.08.

The structural color particles 12 which form the structural color particle layer 15 may be an element composed of a single composition, or may be a compound. Further, the aforesaid structural color particles may be a particle on which surface a substance, by which the structural color particles are allowed to adhere to each other, is adhered, or may be a particle within which a substance, by which particles are allowed to adhere to each other, is introduced. By employing such an adhesive, particles are allowed to adhere to each other, even if the structural color particles are made of materials which are hard to self-arrange during formation of the structural color particle layer 15. Further, in the case where the structural color particles are formed employing materials exhibiting a high refractive index, a material exhibiting a low refractive index may be added internally.

The structural color particles 12 which form the structural color particle layer 15 have preferably a high degree of mono-dispersibility so as to easily achieve a regular arrangement during formation of the s structural color particle layer 15.

To obtain spherical bodies exhibiting high mono-dispersibility, in the case where the spherical bodies are composed of organic materials, the aforesaid spherical bodies are preferably prepared via generally commonly used polymerization methods such as soap-free emulsion polymerization, suspension polymerization, and emulsion polymerization.

The structural color particles 12 may be subjected to various surface treatments to make the particles exhibit a high affinity to matrix M.

### [Matrix]

A material for a matrix M which forms a structural color display layer 10 is not particularly limited, it may be a solid or it may be air. When the matrix M is a solid, the obtained structural color display layer 10 becomes to have a high strength, a high peeling off property for structural color particles, and a high flexibility. When the matrix M is a solid, the material for forming the matrix M can be suitably selected from materials whose refractive indices differ from that of the structural color particles 12. Further, the materials which form the matrix M preferably have a high affinity to the structural color particles 12.

When the matrix M is a solid, the refractive index of the matrix M can be determined by various commonly known methods, but the refractive index of the matrix M of the present invention is determined such that a thin film comprising only the matrix M is separately prepared and the thin film is measured using an Abbe Refractometer.

Specific refractive indexes for the matrix M are, for example, 1.41 for silicone gel, 1.53 for gelatin/acacia gum, 1.51 for polyvinyl alcohol, 1.51 for sodium polyacrylate, 1.34 for fluorine modified acrylic resin, 1.51 for N-isopropyl amide, and 1.43 for foamed acrylic resin.

When the matrix M is a solid, examples of the material for forming the matrix M are: a resin which is soluble in an organic solvent; a hydrogel; an oil gel; a photo-curable agent; a thermo-curable agent; and a moisture-curable agent.

The material which forms the matrix M is preferably a liquid during the manufacturing process of coating to periodic structure body 16, and will be solidified by receiving energy of heat or light. Specific resins which are soluble in an organic solvent include: a polystyrene resin, an acrylic resin, and a polyester resin. Water-soluble resins include a polyacrylic acid, a polyvinyl alcohol, and a polyvinyl chloride. Specific hydrogels include a gel which is prepared by blending water and a gelling agent such as a gelatin, a carrageenan, a polyacrylic acid, and a sodium polyacrylate. Oil gels include a silicone gel, a fluorine silicone gel, and a gel which is prepared by blending a gelling agent such as amino acid derivatives, cyclohexane derivatives, and polycyclohexane derivatives, with silicone oil or an organic solvent.

In particular, the matrix M which forms the structural color display layer 10 of the structural color display material of the present invention is preferable to have a water contact angle (60 to 100°) similar to that of the surface of the substrate 13 for a structural color display layer, from the viewpoint of obtaining a good adhesion state with the substrate 13 for a structural color display layer. Preferable examples are: an acrylic resin, polyethylene, a fluorine containing resin and a silicone resin. Among these, a silicone resin is most preferably used.

The aforesaid structural color display layer 10 may be provided with a transparent surface protective layer through the adhesive layer on structural color display layer 10. As a surface protective layer, it can be used a film which has a high transparency and does not prevent recognition of a structural color exhibited by the structural color display layer 10. Examples are films which can be used are made of polyethylene terephthalate (PET), polyethylenenaphthalate (PEN) and a UV curing resin. This surface protective layer remains on the structural color display layer 10, even after being stuck on a surface of an object.

### [Adhesive Layer]

The adhesive layer 17 which composes the structural color display material of the present invention is a layer which is adhered to a surface of an object. The adhesive layer 17 is preferable to exhibit an adhesion force of 1,000 g/25 mm width or more measured according to JIS Z 1538 against a flat stainless plate whose surface is cleaned with a fat removing solvent (such as alcohol) in the state where the adhesive layer 17 is coated on the substrate 13 for a structural color display layer. By providing with the aforesaid adhesive layer 17, it is possible to satisfy the following requirements: when the aforesaid structural color display material is cut, it is required that the adhesive agent does not stick to a cutting edge, specifically to a rotary slitter cutting edge, or a guillotine cutting edge; it is rap sired to have suitable adhesion to releasing material 18 which will be mentioned later; it is required that it will exhibit a sufficient adhesive force to the releasing material 18 in such a manner that the releasing material 18 will not be peeled off when cutting processing is done or the structural color display layer 10 is formed; and it is required that the adhesive layer 17 does not exfoliate from the substrate 13 for a structural color display layer with the releasing material 18, when the structural color display layer 10 is formed on the substrate 13 by firmly adhering to it.

An adhesive force of an adhesive agent can be specifically measured as follows. On one side of a commercially available polyethylene terephthalate having a thickness of 100 μm is coated and dried an adhesive agent so as to form an adhesive layer having a coating amount of 15 g/m². It is cut in a size of 25 mm×500 mm (coated portion of 25 mm×250 min), and it is faced to a flat stainless plate having a size of 25 mm×500 mm and cleaned with alcohol so that the both shapes correspond and the adhesive agent faces to the stainless plate. Then both are adhered with a roller having a weight of 2 kg by rotating three times at a temperature of 23° C. and a humidity of 55% RH. After 24 hours, the edge of the stainless plate on which the adhesive agent is not contacted is held with a clamp of Instron Tensile Testing Machine at a temperature of 23° C. and a humidity of 55% RH in accordance with a method of JIS Z 1538. And, the edge of the polyethylene terephthalate film on which the adhesive agent is not coated is suspended down and this edge is held with a clamp. The polyethylene terephthalate film is stretched in a direction of 180° at a rate of 300 mm/minute with Instron Tensile Testing Machine. The load at which the polyethylene terephthalate film is peeled off is measured and this is designated as an adhesive force.

As an adhesive agent constituting the aforesaid adhesive layer 17, well-known various materials can be used. For example, the materials which have a prescribed adhesion force can be chosen from: an ethylene-vinyl acetate resin, an acrylic system emulsion resin, a vinyl chloride system resin, a vinylidene chloride system resin, a synthetic rubber system resin and a natural rubber system resin.

Specific examples of such adhesive agents are: SAIBINOL X-491-267E, SAIBINOL X-491-268E, SAIBINOL X-490-213E, SAIBINOL X-490-229 (made by Saiden Chemical Industry Co., Ltd.); NIKASOL TS-1413, NIKASOL TS-1436, NIKASOL TS-1446, NIKASOL TS1448 (made by Nippon Carbide Industry Co., Ltd.); and ACRONAL K-0672, the ACRONAL K-0611, ACRONAL I-0510 and ACRONAL G-0412 (made by Mitsubishi Petrochemical Badische Co., Ltd.) Moreover, an acrylic system latex disclosed in JP-A No. 4-298586 and JP-A No. 3-6277 can also be used as an adhesive agent.

It is preferable that the adhesive layer 17 has a coating amount of 5 to 25 g/m². It is more preferable that the coating amount is 10 to 20 g/m² from the viewpoints of the ease of cutting and the stability of adhesive force after adhered to a surface of an object.

As an application method of an adhesive agent, it can be suitably chosen according to the types of the adhesive agent, such as a solvent type adhesive agent, an emulsion type adhesive agent, or a hot melt adhesive agent. For example, it can be applied using a reverse roll coater, an air knife coater, a knife applicator, or a die applicator.

In the adhesive layer 17, various materials can be added to such an extent that adhesion characteristics are not spoiled. Examples thereof are: a pigment such as titanium oxide, calcium carbonate, barium sulfate, zinc oxide, silica, kaolin and clay; an antistatic additive; and an antiseptic. Moreover, a water-soluble plasticizer disclosed in JP-A No. 4-298586 can also be added.

### [Releasing Material]

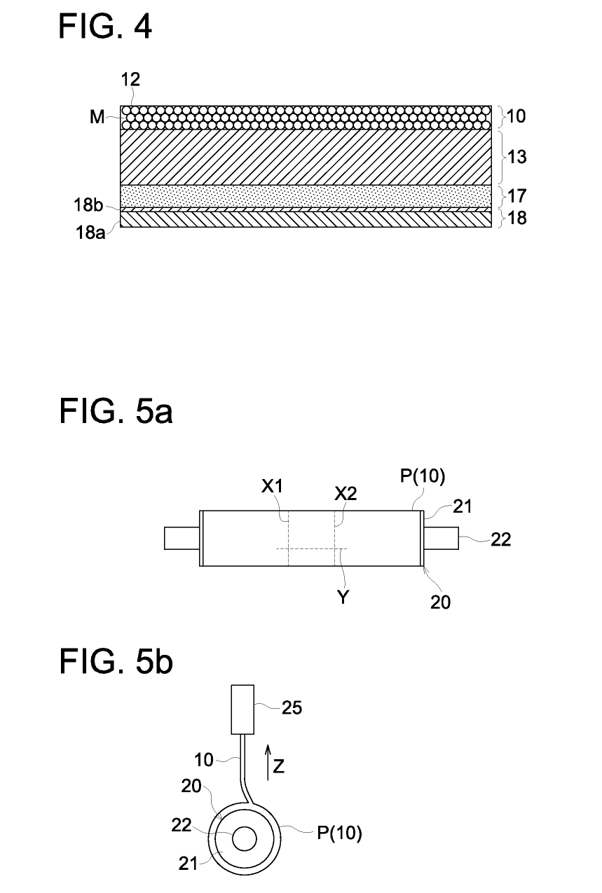

The structural color display material of the present invention is preferably provided with a releasing material 18 on the other side (the reverse side) of the adhesive layer 17 opposite to the side on which is contacted the substrate 13 for a structural color display layer as is shown in FIG. 4. This releasing material 18 exposes the adhesive layer 17 by being peeled off the releasing material 18 when it is used. It can have a structure in which a releasing agent layer 18b is formed on a substrate sheet 18a in such a manner that the releasing agent layer 18b is contacted with the adhesive layer 17. The substrate sheet 18a is not specifically limited. It is preferable that the substrate sheet 18a can resist to the production process using an aqueous medium. For example, it is preferable to use a plastic film or a coated paper which is formed a resin layer on the entire side of the paper support contacting to the adhesive layer 17.

It can be used a common paper support for a separating paper (substrate sheet) without specific limitation as a paper support of a coated paper. In the same manner as for the paper support used for the substrate 13 for a structural color display layer, it is preferable to blend an additive at the time of paper making such as: a sizing agent, a fixing agent, a tensile force enhancement agent, a loading material, an antistatic agent, a dye and an antifoggant. When paper support itself has a water fastness, it can be prevented penetration of an aqueous medium from a cut surface during the production process of coating the structural color particle dispersion liquid which will be mentioned later. It can be prevented deterioration of the quality of the obtained structural color display material by this.

As a resin layer formed on the both surfaces of the paper support, it can be cited a resin layer for the coated paper used for the above-mentioned substrate 13 for a structural color display layer. Particularly, a resin layer made of polyolefin is preferably used. Examples of a polyolefin resin include: a polyethylene resin, a polypropylene resin and a poly(co-ethylene-co-propylene) resin. It is preferable to use a polyethylene resin from a viewpoint of the ease of handling in manufacturing process. The polyethylene resin can be used without problem, whether it is lower density or high density.

Examples of a plastic film include: a polyester film which is made of polyethylene terephthalate, polyethylene naphtholate, or modified polyester, a polyolefin film which is made of polyethylene or polypropylene; a polystyrene film; a polyvinyl chloride film; and a polycarbonate film.

The thickness of the substrate sheet 18a is preferably, for example, in the rage of 20 to 100 μm.

As a releasing agent which constitutes the releasing agent layer 18b of the releasing material 18, well-known various kinds of silicone resins can be used. Particularly, it is preferable to use releasing agent having a dynamic friction coefficient of 0.21 or more with a chloroprene rubber having Shore A hardness of 65±2° measured with the method in accordance with JIS P 8147. More preferably, it is 0.21 to 0.50. With respect to the structural color display material which has the releasing material 18 formed using such a releasing agent, the adhesive agent which constitutes the adhesive layer 17 will not be easily adhered to a guillotine cutting edge or to a rotary slitter cutting edge during the cutting operation.

Specific examples of a releasing agent include: LTC-350A, BY14-403, BY14-405, BY14-407, BY14-413, BY14-414, BY14-411, BY14-420 (made by Toray Dow Corning Silicone Co., Ltd.); and KS-845, KS-770″, KNS-202A, KNS-305, KNS-316, KNS-319, KNS-320, X-62-1232, X-62-1233 (made by Shin-Etsu Chemical Co., Ltd.)

The thickness of the releasing agent layer 18b is preferably, for example, set to have a coating amount of the releasing agent in the range of 0.4 to 2.0 g/m², and more preferably, the thickness is set to have a coating amount of the releasing agent in the range of 0.6 to 1.3 g/m².

### [Preparation Method of Structural Color Display Material]

The above-described structural color display materials are produced by the following ways. For example, when it is provided with a release material, there are the following methods: (1) a releasing agent is applied on a substrate sheet 18a of a release material 18 to form a releasing agent layer 18b. Then, on the aforesaid releasing agent layer 18b is applied an adhesive agent to form an adhesive layer 17. These are pasted together by passing them through a press roll in the state where the adhesive layer 17 is contacted with the rear surface of the substrate 13 for a structural color display layer. Subsequently, a structural color display layer 10 is coated on the front surface of the substrate 13 for a structural color display layer; and (2) an adhesive agent is applied to the rear surface of the substrate 13 for a structural color display layer to form an adhesive layer 17. On the other hand, a releasing agent is applied to the sheet 18a of the release material 18 to form the releasing agent layer 18b. These are pasted together by passing them through a press roll in the state where the adhesive layer 17 is contacted with the releasing agent layer 18b. Subsequently, the structural color display layer 10 is coated on the front surface of the substrate 13 for a structural color display layer.

In addition, the method of providing the adhesive layer 17 after obtaining a substructure having the structural color display layer 10 formed on the surface of the substrate 13 for a structural color display layer beforehand contains a complicated process, and it is hard to achieve a large sized area. As a result, this method is not preferable.

### [Preparation Method of Structural Color Display Layer]

The above-described structural color display layer 10 can be prepared by the following method. For example, the specific method contains the following steps: to prepare a structural color particle dispersion liquid by dispersing structural color particles 12 in an aqueous medium; on a surface of the substrate 13 for a structural color display layer having provided with the adhesive layer 17 and exhibiting a water contact angle 60 to 100°, to coat the aforesaid structural color particle dispersion liquid to perform self-arrangement of the particles; to make form a periodic structure body 16 in which the structural color particles 12 are arranged regularly; and to dry the periodic structure body 16 to remove the aqueous medium.

In this method, as a structural color particle dispersion liquid, it can be further used a material for forming a matrix M in the state of solution or dispersion. By this process, a solid matrix M can be suitably introduced.

Moreover, as a structural color particle dispersion liquid, it is possible to use the dispersion liquid which does not contain a material for forming a matrix M. By coating a solution containing a material for forming the matrix M on the produced periodic structure body 16, it is possible to suitably introduce the solid matrix M by completely filling up the space among the structural color particles 12 followed by making it to solidify.

Here, “an aqueous medium” means a medium which is composed of water in an amount of 50 to 100 weight % and a water-soluble organic solvent in an amount of 0 to 50 weight %. Examples of an aqueous medium include: methanol, ethanol, isopropanol, butanol, acetone, methyl ethyl ketone and tetrahydrofuran. Since a resin is not dissolved in an alcoholic solvent, an alcoholic system organic solvent is preferably used.

Examples of the methods used for coating the dispersion of the structural color particles 12 include: a screen coating method, a dip coating method, a spin coating method, a curtain coating method and a LB (Langmuir-Blodgett) film forming method.

### [Surface Treatment of Structural Color Display Layer Substrate]

When the structural color display layer 10 is formed using the above-describe aqueous dispersion liquid, it is preferable to perform activation on the surface of the substrate 13 for a structural color display layer to give hydrophilicity to it.

Specifically, it is possible to perform activation on the surface in contact with the structural color display layer 10. Examples of activation includes: a corona discharge treatment, a flame treatment, a glow discharge treatment, an UV light irradiation treatment, a high-frequency treatment, an activity plasma treatment and laser treatment

The above-described structural color display material can be made into a sheet, for example. In a sheet type of structural color display material, it is preferable that the releasing material 18 is formed on the side (a rear surface) of the adhesive layer 17 opposite to the side of the adhesive layer 17 contacted with the substrate 13 for a structural color display layer, when it is not stuck on the surface of an object.

Moreover, for example, it can also be made into a roll shape. In a roll type of structural color display material, at the state in which it is not stuck on the surface of an object, the roll is made in such a manner that the adhesive layer 17 is contacted with the surface of the protective layer, when the protective layer is provided on one surface of the structural color display layer opposite the other surface of the structural color display layer on which the substrate 13 for a structural color display layer is contacted.

The above-described structural color display material is used to be adhered on a surface of an object. This structural color display material can be cut according to the purpose of use. As a cutting edge which cuts this structural color display material, there are used: a slitter, a rotary cutter, a cross cutter, a guillotine cutter, and a punching cutter as well as a seal cutter which punches out the material by leaving only the aforesaid releasing material. By using any cutters cited, the adhesive agent does not adhere to a cutting edge without falling off, and high working efficiency is acquired.

According to the above-described structural color display material, since the structural color display layer 10 exhibiting a structural color is formed on a surface of the substrate 13 for structural color display layer, the surface having a specific high water contact angle, it can be achieved a sufficient fixing state between the structural color display layer 10 and the substrate 13 for structural color display layer. Therefore, it can be obtained high integration between the structural color display layer 10 and the adhesive layer 17 though the substrate 13 for structural color display layer. As a result, when the force from the outside is applied in the state where the adhesive layer 17 is stuck on a surface of an object, peeling of the structural color display layer 10 does not arise. Consequently, the quality of the stuck structural color display layer 10 can be held.

According to the structural color display material described above, since the periodic structure body 16 is formed on the substrate 13 for structural color display layer which has been provided with the adhesive layer 17 beforehand by coating a with a structural color particle dispersion which is made by dispersing the structural color particles 12 in an aqueous medium, the complexity of the process is highly reduced compared with a method in which the adhesive layer 17 is provided after forming the structural color display layer 10. Further, the method of the present invention can easily produce a large sized material.

As mentioned above, although the embodiments of the present invention were described concretely, the embodiments of the present invention are not limited to the above-mentioned examples, and various modifications can be made.

### EXAMPLES

Hereinafter, specific embodiments of the present invention will be described, however, the present invention is not limited to these. In addition, measurements for the followings were performed in the same ways as mentioned above: an average particle diameter and a CV value of the particles for structural color; a water contact angle of the front surface and the rear surface of the substrate for structural color display layer; a dynamic friction coefficient of the releasing agent used for a releasing material; and an adhesive force of an adhesive agent.

### Examples 1 to 4

### Comparative Examples 1 to 3

### (1) Preparation of Releasing Agent

As a substrate sheet of a releasing material, a polyethylene terephthalate film having a thickness of 75 μm was prepared (“Tetron film”, made by Teijin, Ltd.) On both surfaces of this substrate sheet was applied a releasing agent “SD-7239” (made by Toray Dow Corning Silicone Co., Ltd., having a dynamic friction coefficient of 0.25) in an amount of a dry coating weight of 1.0 g/m² with a bar coater. Then it was dried to form a releasing agent layer. Subsequently, the releasing material was produced by winding this.

### (2) Preparation of Adhesive Layer

Next, on one surface of the aforesaid releasing material was coated a adhesive agent “SAIBINOL X-491-268E” (made by Saiden Chemical Industry Co., Ltd., adhesive force of 1,500 g/25 mm) in an amount of a dry coating weight of 16 to 18 g/m² with a reverse roll coater. The coated adhesive agent was dried to form an adhesive layer. Another separating paper of the same type of paper used for the releasing material was placed on the surface of the aforesaid adhesive layer and they were wound to prepare a releasing material provided with an adhesive layer.

### (3) Preparation of Structural Color Display Layer Substrate

### [Structural Color Display Layer Substrate (1): Coated Paper]

There were mixed 40% of sulfate bleached needle-leaved tree pulp (NBSP) of a photographic paper grade and 60% of sulfite bleached broad-leaved tree pulp (LBKP) of the photographic paper grade to form a pulp slurry having a concentration of 1.2%. In the slurry were added, as a ratio over a pulp (dry mass), 0.82% of polyamide polyamino epichlorohydrin resin, 0.45% of alkyl ketene dimer, 2.10% of cation starch and 0.12% of anionic polyacrylamide resin. Then the mixture was adjusted to pH 7.6 with sodium hydroxide. After fully dispersing this pulp slurry, a paper support (1) having a basis weight of 70 g/m² and a density of 1.0 μg/m² was produced with a paper machine.

On the other hand, polyethylene resin chips (density: 0.95 glee; melt index (MI): 8.0 g/10 minutes) were dried. They were put into an extruder and melted at 300° C. The prepared melt was coated on the rear surface (the side on which the adhesive layer is formed) of the above-described paper support (1) through a die slit so that the coating amount became 30 g/m². Subsequently, a mixture of 90 weight parts of polyethylene resin (density: 0.92 g/cc; MI: 5.0 g/10 minutes) and 10 weight parts of anatase type titanium oxide was introduced in an extruder and it was knead-melted. The prepared melt was coated on the front surface (the side on which the structural color display layer is formed) of the paper support (1) though a die slit so that the coating amount became 30 g/m² to obtain a structural color display layer substrate (1).

The water contact angle of the surface of the produced structural color display layer substrate (1) was measured. The water contact angle of the surface was 73°.

### [Structural Color Display Layer Substrate (2): Coated Paper]

First, 20 weight parts of epoxy acrylate “NK Ester EA800” (made by Shin-Nakamura Chemical Co., Ltd.), 15 weight parts of polybutadiene “TEA-1000” (made by Nippon Soda Co., Ltd.), 20 weight parts of triethylene glycol diacrylate and 45 weight parts of carbon black “Regal 330R” (made by Cabot Co., Ltd.) as a black were mixed. The mixture was dispersed for 20 hours with a ball mill to obtain an electron beam curable composition (1).

The prepared electron beam curable composition (1) was coated on the front surface (the side on which the structural color display layer is formed) of the paper support (2) which was prepared in the same manner as preparation of the paper support (1) with a roll coating method so that the coating amount became 15 g/m². Then, dried polyethylene resin chips (density: 0.95 glee; melt index (MI): 8.0 g/10 minutes) were put into an extruder and melted at 300° C. The prepared melt was coated on the rear surface (the side on which the adhesive layer is formed) of the paper support (2) through a die slit so that the coating amount became 30 g/m², and it was dried. Thus, a structural color display layer substrate (2) was produced.

The water contact angle of the surface of the produced structural color display layer substrate (2) was measured. The surface water contact angle was 70°.

### [Structural Color Display Layer Substrate (3): Plastic Film]

A black color polyethylene terephthalate film having a thickness of 50 μm “Lumilar X30” (made by Toray Industries, Inc.) was prepared. This was designated as a structural color display layer substrate (3). In addition, nothing was applied to this polyethylene terephthalate film.

The water contact angle of the surface of the produced structural color display layer substrate (3) was measured. The surface water contact angle was 69°.

### [Structural Color Display Layer Substrate (4): Plastic Film]

An ultra-high molecular polyethylene adhesive tape thickness of 50 μm, No. 4430 (made by NITTO DENKO CORP.) was prepared. This was designated as a structural color display layer substrate (4). In addition, nothing was applied to this polyethylene terephthalate film.

The water contact angle of the surface of the produced structural color display layer substrate (4) was measured. The surface water contact angle was 81°.

### [Structural Color Display Layer Substrate (5): Coated Paper]

A structural color display layer substrate (5) was produced in the same manner as preparation of the structural color display layer substrate (1), except that the polyethylene resin was not coated on the front surface of the paper support (1). The water contact angle of the surface of the produced structural color display layer substrate (5) was measured. The surface water contact angle was less than 10°.

### [Structural Color Display Layer Substrate (6): Plastic Film]

On one surface of a black color polyethylene terephthalate film having a thickness of 50 μm “Lumilar X30” (made by Toray Industries, Inc.) was performed a corona discharge treatment with a strength of 8 W/min·m². On the corona discharge treated surface was coated the following surface treatment solution (3) so that the coating amount became 25 ml/m². Again, three was performed a corona discharge treatment with a strength of 8 W/min·m². Further on this surface was coated the following surface treatment solution (4) so that the coating amount became 30 ml/m². Thus, there was produced a structural color display layer substrate (6), with one surface of which being performed a surface treatment. In addition, nothing was applied to the other surface of the polyethylene terephthalate film.

The water contact angle of the surface of the produced structural color display layer substrate (6) was measured. The surface water contact angle was 30°.

### (Surface Treatment Solution (3))

| | |
|---|---|
| Butyl acrylate | 30 g |
| t-Butyl acrylate | 25 g |
| Styrene | 25 g |
| Copolymer latex (solid content: 30%) | 720 g |
| Compound (C-6) | 0.8 g |
| Hexamethylene-1,6-bis(ethylene urea) | 0.8 g |
| Water | to make 1 litter |

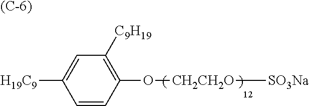

### (Surface Treatment Solution (4))

| | |
|---|---|
| Gelatin | 10 g |
| Compound (C-6) | 0.2 g |
| Compound (C-7) | 0.2 g |
| N, N′, N″-trisacryloy1-1,3,5-trimethylene triamine | 0.1 g |
| Silica particles (average particle size: 0.3 μm) | 0.1 g |
| Water | to make 1 litter |

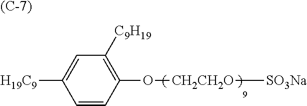

### [Structural Color Display Layer Substrate (7): Plastic Film]

A fluoro resin adhesive tape “NITOFLON No. 903UL” (made by NITTO DENKO CORP.) was prepared. This was designated as a structural color display layer substrate (7). In addition, nothing was applied to this fluoro resin adhesive tape.

The water contact angle of the surface of the produced structural color display layer substrate (7) was measured. The surface water contact angle was 115°.

### (4) Pressure Bonding of Adhesive Layer to Structural Color Display Layer Substrate

With respect to the structural color display layer substrates (1)-(3), (5) and (6), the following process was made. While the separating paper (the substrate sheet) of the releasing material with the adhesive layer was peeling off; the exposed adhesive layer of the releasing material and each of the rear surfaces of the structural color display layer substrates (1)-(3), (5) and (6) was closely contacted. Each of the substrate was pressure bonded to the adhesive layer with a nip roll or a press roll. These were called as structural color display layer substrates sheets (1)-(3), (5) and (6).

With respect to the structural color display layer substrates (4) and (7), they were respectively called as structural color display layer substrates sheets (4) and (7) without change.

### (5) Synthesis of Structural Color Particles

A monomer solution was prepared by mixing 72 weight parts of styrene, 20 weight parts of n-butyl acrylate and 8 weight parts of acrylic acid and heated to 80° C. In addition to that, a surfactant solution was prepared by dissolving 0.2 weight parts of sodium dodecyl sulfonate into 263 weight parts of ion-exchanged water and heated at 80° C. After mixing this surfactant solution with the above-described monomer solution, the mixture was dispersed for 30 minutes using a mechanical dispersing apparatus “CLEARMIX” (made by M Technique Co., Ltd.) to obtain an emulsified dispersion.

To a reaction vessel provided with a stirring apparatus, a heating and cooling apparatus, a nitrogen gas introducing apparatus and a raw material and additive putting apparatus were introduced the aforesaid emulsified dispersion and a surfactant solution prepared by dissolving 0.1 weight parts of sodium dodecyl sulfonate into 142 weight parts of ion-exchanged water. The inner temperature of the mixture was raised to 80° C. while stirring at 200 rpm under a nitrogen gas stream. To this solution was added 1.4 weight parts of potassium persulfate and 54 weight parts of water, and polymerization reaction was performed for 3 hours. A dispersion of particles was obtained. This particle dispersion was treated with a centrifuge to separate large sized particles and small sized particles. Thus it was produced a dispersion (1) containing high sphericity with high mono-dispersibility. The structural color particles (1) in the aforesaid dispersion (1) showed an average particle sized of 250 nm and a CV value of 5.

### (6) Preparation of Structural Color Display Material

### [Preparation of Structural Color Display Materials (1) to (7)]

On a surface of the aforesaid structural color display layer substrate sheets (1)-(7) opposite the adhesive layer was coated the aforesaid dispersion (1) with a bar coating method. The coated layer was dried for 20 minutes under a condition of a temperature of 20° C. and a humidity of 50% RH to form a periodic structure body having a thickness of 20 μm and a size of 100 cm×100 cm. Subsequently, silicone gel was applied from the periodical structure body, and the coating solution was allowed to penetrate among the structural color particles. After heating for one hour at 60° C., structural color display materials (1) to (7) were obtained.

The fixing force between layers of each of the structural color display layer substrate and the structural color display layer in the above-described structural color display materials (1) to (7) was measured.

Specifically, as shown in FIG. 5a, a structural color display material P was pasted on a hollow cylinder roller 20 (outside diameter: 28 mm, thickness: 1 mm) with which flanges 22 was provided to the both ends of sleeves 21 made of aluminium. The structural color display layer 10 in the center portion of the structural color display material P which was pasted on the roller 20 was cut along with the outer periphery of the sleeve 21 having a width of 2.5 cm (broken lines X1 and X2). Another cut (broken line Y) was made perpendicularly to these cuts, and a small amount of the structural color display layer 10 was peeled off from there. As shown in FIG. 5b, the end of the peeled structural color display layer 10 was pinched with a grip 25 of “Autograph AGS” (made by Shimadzu Corp.) and it was pulled up with a velocity 100 mm/min in the direction perpendicular to the surface of the roller 20 as shown in an arrow Z. A loading volume was set to 20 N, the loading value at which the structural color display layer 10 can be pulled up, even if the load was not increased, was measured as a force which begins peeling of the structural color display layer 10 from the structural color display layer substrate 13. This value was determined to be the fixing force between layers. The case where the fixing force between layers was 5.0 N or more was evaluated as “Good” (it can be satisfied enough and it is sufficient for practical use). The case where the fixing force between layers is less than 5.0 N was evaluated as “Not good” (there is a problem for practical use). The evaluation results are shown in the following Table 1.

TABLE 1

| | | Structural color display layer substrate | | | | Evaluation result |
|---|---|---|---|---|---|---|
| | Structural color display | | | | Contact angle(° C.) | Fixing force between |
| | material No. | No. | Type | Material | Surface | layers |
| Example 1 | 1 | 1 | Coated paper | Paper + Polyethylene | 73 | A |
| Example 2 | 2 | 2 | Coated paper | Paper + Polyeste | 70 | A |
| Example 3 | 3 | 3 | Plastic film | Polyester | 69 | A |
| Example 4 | 4 | 4 | Plastic film | Polyethylene | 81 | A |
| Comparative | 5 | 5 | Coated paper | Paper only | <10 | B |
| Example 1 | | | | | | |
| Comparative | 6 | 6 | Plastic film | Polyester + Gelatin | 30 | B |
| Example 2 | | | | | | |
| Comparative | 7 | 7 | Plastic film | Fluoro resin | 115 | B |
| Example 3 | | | | | | |

The structural color display material of the present invention has the following characteristics. A high chroma with high reflectance can be obtained form the structural color displayed by the structural color display layer compared with a color display made by the absorption of a light with a dye, since it makes use of reflection of a light. The displayed color by the structural color display material is hardly faded. By making use of these characteristics in coloring, it can be produced, for example, a traffic-control sign which can be adhered with an easy operation without requirement of experience and skill. And, it can be cut in a favorite size and can be stuck. Therefore, it can be uses suitably for tapes for an ornament tape such as a nail seal.

What is claimed is:

1. A structural color display material comprising a sheet of substrate having:
an adhesive layer on a rear surface of the substrate; and
a structural color display layer which comprises structural color particles and a matrix and exhibits a structural color on a front surface of the substrate,
wherein the front surface of the substrate on which is formed the structural color display layer exhibits a water contact angle of 60 to 100°.

2. The structural color display material of claim 1,
wherein the matrix is composed of at least one of an acrylic resin, a polyethylene resin, a polyester resin and a silicone resin.

3. The structural color display material of claim 2,
wherein the matrix is composed of a silicone resin.

4. The structural color display material of claim 1,
wherein the substrate for the structural color display layer is a plastic film, or a coated paper having a resin layer on each of a front surface and a rear surface of a paper support.

5. The structural color display material of claim 1,
wherein the substrate shows flexibility.

6. The structural color display material of claim 1,
wherein a releasing material is provided on one surface of the adhesive layer, the one surface of the adhesive layer is opposite the other surface of the adhesive layer, and the opposite surface of the adhesive layer is in contact with the substrate for the structural color display layer.

7. The structural color display material of claim 1,
wherein a transparent protective layer is provided on one surface of the structural color display layer, the one surface of the structural color display layer is opposite the other surface of the structural color display layer, and the opposite surface of the structural color display layer is in contact with the substrate for the structural color display layer.

8. A method for producing the structural color display material of claim 1, comprising the steps of:
applying a structural color particle dispersion containing the structural color particles dispersed in an aqueous medium on the front surface of the substrate for the structural color display layer to form a periodic structure body which exhibits a structural color,
provided that the substrate is provided with the adhesive layer on the rear side of the substrate, and the front surface of the substrate on which is formed the structural color display layer exhibits a water contact angle of 60 to 100°.
